(19) United States
(12) Patent Application Publication
(10) Pub. No.: US 2019/0156413 A1
(43) Pub. Date: May 23, 2019

(54) METHOD AND SYSTEM FOR REAL TIME INSTALLMENT OPTIONS ON INTER- AND INTRA-BANK TRANSACTIONS

(71) Applicant: Mastercard International Incorporated, Purchase, NY (US)

(72) Inventor: Vidit BHARGAVA, Maharashtra (IN)

(73) Assignee: Mastercard International Incorporated, Purchase, NY (US)

(21) Appl. No.: 15/819,333

(22) Filed: Nov. 21, 2017

(51) Int. Cl. G06Q 40/02; G06Q 20/08

(52) U.S. Cl. CPC G06Q 40/025; G06Q 20/0855

(57) ABSTRACT

A method for creating an installment for an inter-bank transaction includes: storing account credentials associated with a first transaction account issued by a first financial institution; receiving an account number associated with a second transaction account issued by a second financial institution and full payment amount; transmitting an eligibility request to a third party system, the eligibility request including the account credentials, account number, and full payment amount; receiving proposed installment terms including a first installment amount; receiving an indication of acceptance of the proposed installment terms; transmitting the indication of acceptance of the proposed installment terms; receiving a controlled payment number associated with the second transaction account; and initiating an inter-bank transaction for transfer of the first installment amount from the first transaction account to the second transaction account using the controlled payment number.

### FIELD

The present disclosure relates to the creation of an installment for an inter-bank transaction, specifically the use of controlled payment numbers and a dedicated platform enabling real-time creation of an installment loan for an inter- or intra-bank transaction.

### BACKGROUND

In the United States and many European countries, payment transactions are typically conducted via a single transfer of funds: the consumer pays the merchant the full amount of a transaction. In some countries, such as Brazil, installments are the primary mechanism for payment: the consumer will pay the merchant an initial amount and then regularly repeat payment over a period of time. Installments can provide several benefits to consumers, including the ability to buy large ticket items over a period of time, often at a more favorable interest rate than may be provided via loans or a line of credit. As such, some methods have been developed to enable standard transactions to be converted to an installment post-approval of the transaction.

Such methods often involve the issuing financial institution that issued the transaction account that funded the transaction to pay the merchant (or an acquirer acting on behalf of the merchant) the full amount, but deduct a series of installment payments from the consumer's account at regular intervals over the period of time. Such methods can enable a consumer to reap the benefits of an installment, even when a merchant does not directly offer installments, and can be adapted to any and all merchants. However, such methods are only configured to operate using standard payment transactions between a consumer and a merchant. That is, the post-transaction conversion to an installment loan does not pose a significant change in the computer networks that can be used to implement them. This is not so when it comes to inter- and intra-bank transfers, which do not have the ability to create installment loans, particularly on a mass scale in in the timeframes a consumer has come to expect bank transfers to take. Thus, there are no methods that allow for the creation or use of installments with respect to inter- or intra-bank transfers, like wire transfers, and doing so would seemingly involve a complete redesign of the inter- and intra-bank transfer networks. The closest alternative available to consumers at this time is to take out a loan to cover the amount being transferred. However, loans often take a significant amount of time to approve and process and require in-depth verification processes, and are thus typically unsuitable for use when an inter- or intra-bank transfer is to be made.

Thus, there is a need for a technical solution to enable the creation of an installment in real-time for a proposed inter- or intra-bank transaction.

### SUMMARY

The present disclosure provides a description of systems and methods for creating an installment for an inter- or intra-bank transaction. A dedicated platform is designed to help create an installment for a proposed wire transfer or other type of inter- or intra-bank transaction, which communicates directly with the user seeking the installment and a first issuing institution from which the transfer is being made, either to a second issuing institution or to a second account issued by the same institution. It is implemented to use parts of the inter- and intra-bank transfer networks, but also use concepts and technology adapted from the payment card industry that provides a non-obvious and technical solution to this problem of trying to adapt the wire transfer networks.

The platform facilitates the creation of a controlled payment number to whom payment is made by the user to affect the wire transfer in a manner that can be tracked and managed as an installment, where the platform assists the issuing institution in the management thereof. The use of the third party platform can thus accommodate for installments for inter- and intra-bank transfers in real time with minimal modification to existing issuing institution systems, decreasing the time and resources required for adoption while vastly increasing the features provided to the user.

A method for creating an installment for an inter-bank transaction includes: storing, in a memory of a computing device, account credentials associated with a first transaction account, wherein the first transaction account is an account issued by a first financial institution; receiving, by an input device interfaced with the computing device, at least an account number and full payment amount, wherein the account number is associated with a second transaction account issued by a second financial institution; electronically transmitting, by a transmitting device of the computing device, an eligibility request to a third party system, wherein the eligibility request includes at least the account credentials, the account number, and the full payment amount; receiving, by a receiving device of the computing device, proposed installment terms, wherein the proposed installment terms include at least a first installment amount; receiving, by the input device interfaced with the computing device, an indication of acceptance of the proposed installment terms; electronically transmitting, by the transmitting device of the computing device, the indication of acceptance of the proposed installment terms; receiving, by the receiving device of the computing device, a controlled payment number associated with the second transaction account; and initiating, by the computing device, an inter- or intra-bank transaction for transfer of the first installment amount from the first transaction account to the second transaction account using the controlled payment number.

A system for creating an installment for an inter- or intra-bank transaction includes: a memory of a computing device configured to store account credentials associated with a first transaction account, wherein the first transaction account is an account issued by a first financial institution; an input device interfaced with the computing device configured to receive at least an account number and full payment amount, wherein the account number is associated with a second transaction account issued by a second financial institution; a transmitting device of the computing device configured to electronically transmit an eligibility request to a third party system, wherein the eligibility request includes at least the account credentials, the account number, and the full payment amount; and a receiving device of the computing device configured to receive proposed installment terms, wherein the proposed installment terms include at least a first installment amount, wherein the input device interfaced with the computing device is further configured to receive an indication of acceptance of the proposed installment terms, the transmitting device of the computing device is further configured to electronically transmit the indication of acceptance of the proposed installment terms, the receiving device of the computing device is further configured to receive a controlled payment number associated with the second transaction account, and the computing device is configured to initiate an inter-bank transaction for transfer of the first installment amount from the first transaction account to the second transaction account using the controlled payment number.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for creating installments for inter- and intra-bank transactions in accordance with exemplary embodiments.

FIG. 2 is a block diagram illustrating the computing device of the system of FIG. 1 for creating an installment for an inter-bank transaction in accordance with exemplary embodiments.

FIGS. 3A and 3B are a flow diagram illustrating a process for the creation and implementation of an installment in real-time for an inter-bank transaction using the system of FIG. 1 in accordance with exemplary embodiments.

FIG. 4 is a flow chart illustrating an exemplary method for creating an installment for an inter-bank transaction in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Controlled Payment Number—Controlled payment numbers may be payment numbers associated with a payment account that are subject to one or more rules. In many cases, these rules may be set by a cardholder, such as spending limits, limits on days and/or times of a transaction, limits on merchants or industries, transaction spending or frequency limits, etc. Controlled payment numbers may offer an account holder an opportunity to give payment cards tied to the account to others for use, but subject to rules set by the cardholder, such as an employer distributing cards to employees, or a parent distributing cards to children. Additional detail regarding controlled payment numbers may be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. Pat. No. 7,359,880, issued Apr. 15, 2008; U.S. Pat. No. 7,895,122, issued Feb. 22, 2011; U.S. Pat. No. 8,229,854, issued Jul. 27, 2012; U.S. Pat. No. 8,321,315, issued Nov. 27, 2012; U.S. Pat. No. 8,510,218, issued Aug. 13, 2013; U.S. Pat. No. 8,639,623, issued Dec. 27, 2012; U.S. Pat. No. 8,756,150, issued Jun. 17, 2014; and U.S. Pat. No. 8,527,416, issued Sep. 3, 2013, each of which are herein incorporated by reference in their entirety.

### System for Real-Time Creation of Installments for Inter-Bank Transactions

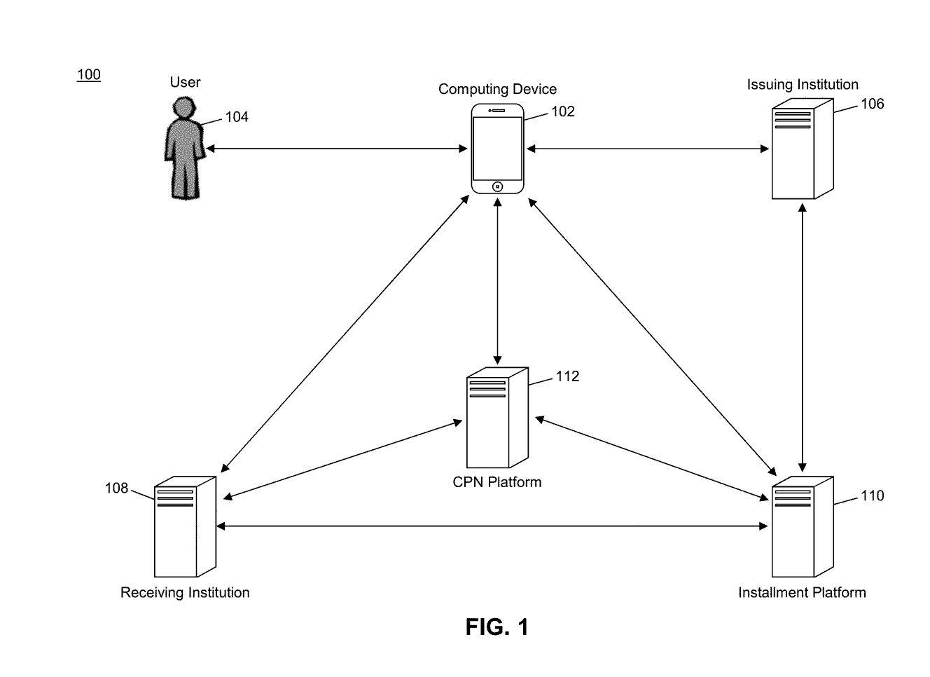

FIG. 1 illustrates a system 100 for the creation of installments in real-time for proposed inter- and intra-bank transactions, collectively referred to herein as “wire transfers” or “inter-bank transactions,” via the use of a dedicated installment platform and a user computing device configured to facilitate the creation of the installment on behalf of a user.

The system 100 may include a computing device 102. The computing device 102, discussed in more detail below, may be operated by a user 104 and configured to enable the creation of an installment for a proposed inter-bank transaction through the use of an installment platform 110. The computing device 102 may be any suitable type of device that has been specifically configured to perform the functions discussed here, such as a specially configured desktop computer, laptop computer, notebook computer, tablet computer, cellular phone, smart phone, smart watch, smart television, etc. The computing device 102 may be operated by the user 104 including the providing of one or more input devices interfaced therewith, as discussed below, through which the user 104 may provide instructions and otherwise input data into the computing device 102.

In the system 100, the user 104 may want to make an inter-bank transfer from a transaction account issued to the user 104 by an issuing institution 106. The issuing institution 106 may be a financial institution, such as an issuing bank, or other suitable type of entity that is configured to issue transaction accounts that may be used as a funding source of an inter-bank transaction. The issuing institution 106 may issue a transaction account to the user 104 that is capable of funding inter-bank transactions and, as part of the issuing of the transaction account, may provision account credentials to the computing device 102. The account credentials may be provisioned using any suitable method and via any suitable type of communication network, such as via cellular communication, the Internet, etc. The account credentials may be comprised of data that is necessary to be provided to the issuing institution 106 to successfully process an inter-bank transaction funded via the transaction account. Account credentials may include, for instance, a primary account number, name, billing address, personal identification number or password, etc.

The user 104 may want to make an inter-bank transfer from the transaction account, referred to herein as the “first” transaction account or the “funding” transaction account, to another transaction account, referred to herein as the “second” transaction account or “receiving” transaction account. In some embodiments, the second transaction account may also be issued by the issuing institution 106, thus making a transaction for transfer of funds from the first transaction account to the second transaction account an intra-bank transaction. In other embodiments, the second transaction account may be issued by a receiving institution 108, which may be a financial institution, such as an issuing bank, or other entity configured to issue transaction accounts. In such embodiments, the transaction may thus be an inter-bank transaction. In some instances, the second transaction account may be issued to the user 104. In other instances, the second transaction account may not be directly associated with the user 104.

In order to facilitate the inter-bank transaction, the user 104 may be provided with account information associated with the second transaction account, including at least an account number associated with the second transaction account. In some embodiments, the receiving institution 108 may provide the account number directly to the user 104 (e.g., via the computing device 102), such as via an application program executed by the computing device 102, a web page, a short messaging service message, e-mail, telephone, etc. In other embodiments, the user 104 may receive the account number from a third party (e.g., another user, such as one to whom the second transaction account was issued), which the user 104 may manually enter into the computing device 102 using an input device thereof. In some embodiments, the computing device 102 may utilize an application program for communicating with the installment platform 110 that is directly associated with (e.g., operated by or on behalf of) the issuing institution 106.

To begin the process of creating an installment for the inter-bank transaction, the user 104 may submit an eligibility request to an installment platform 110. The installment platform 110 may be a third party system that is configured to operate on behalf of issuing institutions 106 and receiving institutions 108 to create and management installments via performing the functions discussed herein, including determining eligibility of transaction accounts for funding and receiving installments, determining installment terms, facilitating the supplying of controlled payment numbers, etc. The user 104 may submit the eligibility request to the installment platform 110 via the computing device 102 using any suitable method, such as via a web page, an application program executed by the computing device 102, a short messaging service message, e-mail, etc. The eligibility request may include at least the account credentials associated with the first transaction account, the account number associated with the second transaction account, and the full payment amount to be made in the inter-bank transaction. In some embodiments, the eligibility request may also include one or more desired installment terms, discussed in more detail below.

The installment platform may receive the eligibility request and determine if both transaction accounts are eligible for participation in the system 100 to have an installment created for an inter-bank transaction involving the respective transaction account. In some embodiments, eligibility may be determined by identifying that the account is a valid transaction account (e.g., the account credentials or account number corresponds to transaction account that exists and is allowed to send/receive funds). In other embodiments, only transaction accounts registered with the installment platform 110 by the appropriate entity (e.g., the issuing institution 106 or receiving institution 108) may be eligible for use in the system 100. In such embodiments, eligibility may be determined for the eligibility request by identifying if the first and second transaction accounts have been previously registered with the installment platform 110.

If the eligibility check passes successfully, then the installment platform 110 may identify installment terms for an installment to be created to affect the inter-bank transaction. The installment terms may include at least a first installment amount, and may also include any other terms that may be necessary for the implementation of an installment, such as a number of payments, payment interval, interest rate, installment amount, payment schedule, etc. In cases where the eligibility request included desired installment terms, the installment terms identified by the installment platform 110 may be based on the desired installment terms. For instance, the user 104 may specify that they would like to have eight installments, and thus the installment platform 110 may identify terms that would facilitate the transaction being funded via eight installment payments, where the interest rate, installment amount, and payment interval may be adjusted to accommodate the user's desire.

In some embodiments, the issuing institution 106 and/or receiving institution 108 may specify parameters (e.g., during the registration of the respective transaction accounts) to be followed by the installment platform during the identification of the installment terms. For instance, the issuing institution 106 may specify a specific number of installment payments or acceptable range of number of installment payments, provide a required or suggested interest rate, etc. In these embodiments, the installment platform 110 may identify installment terms that satisfy the parameters set forth by both the issuing institution 106 and receiving institution 108. In cases where conflicts may exists in the parameters, the installment platform 110 may have predefined rules for resolution of the conflict, such as defaulting to the issuing institution 106 or receiving institution 108, allowing the user 104 to select between the conflicting terms, selecting terms more favorable to the user 104, or other suitable method.

Once the installment terms are identified, the installment platform 110 may provide the installment terms to the user 104 via the computing device 102. In some cases, the installment terms may be a single set of terms that must be accepted by the user 104 to enable the transaction to proceed. In other cases, multiple set of one or more of the installment terms may be included, where the user 104 may be able to select one of the sets of installment terms. For instance, the user 104 may be presented with three different installment options, each having a different number of payments, interest rate, and/or installment amount. The computing device 102 may receive the installment terms and present them to the user 104 via a display device or other output device interfaced therewith. The user 104 may review the installment terms and, if they find a set of installment terms acceptable, indicate their acceptance to the computing device 102 using an input device interfaced therewith.

Upon acceptance of the installment terms, a controlled payment number (CPN) may be identified for use in the future installment payments. In one embodiment, the computing device 102 may communicate the user's acceptance of the installment terms to the installment platform 110, which may identify the CPN. In other embodiments, the computing device 102 may directly submit a request for a CPN to an additional platform, referred to herein as the CPN platform 112. The CPN platform 112 may be separate from the installment platform 110 and may be configured to identify controlled payment numbers for transaction accounts that are mapped thereto and may be used in place of account numbers for the respective transaction accounts. A controlled payment number may be subject to one or more controls on the usage thereof, such that a proposed transaction that includes the controlled payment number must satisfy the controls in order to be approved. In some embodiments, the installment platform 110 and the CPN platform 112 may be a single platform, where the installment platform 110 may be configured to identify CPNs. In other embodiments, the installment platform 110 or computing device 102 may request the CPN from the CPN platform 112 via a submission thereto using a suitable method.

The CPN platform 112 (e.g., or installment platform 110, as applicable) may be configured to identify a CPN associated with the second transaction account. In some cases, the submission to the CPN platform 112 may include the account number associated with the second transaction account. In other cases, alternative identification data may be provided to the CPN platform 112. The CPN platform 112 may identify a CPN directly associated with the second transaction account, which may also be referred to herein as an “installment number.” The CPN platform 112 may provide the installment number to the installment platform 110, along with information identifying the installment to which the installment number is associated. For instance, in one example, the installment number may be provided with the account number associated with the second transaction account. In another example, the submission to the CPN platform 112 may include a reference number or other identifier that may be included in the message containing the installment number for use by the installment platform 110 in associating the installment number with an eligibility request.

The installment platform 110 may receive the installment number and create an entry into an installment database therein for the installment, which may include at least information identifying the first transaction account, the installment number, and the installment terms that were accepted by the user 104. Once the installment is created, the installment number may be provided to the user 104 by the computing device 102, either from the installment platform 110 or the CPN platform 112. The user 104 may view the installment number, and any other details accompanying thereof, such as the accepted installment terms. In some embodiments, the user 104 may be required to submit a confirmation of acceptance of the installment terms prior to the process proceeding. In other embodiments, the transmission of the installment number to the user 104 may be a notification that does not require a response from the user 104.

Once the installment has been created in the installment platform 110 (e.g., and confirmation received from the user 104, if applicable), the first installment payment may be made via a transfer from the issuing institution 106 to the receiving institution 108 using any suitable method for inter-bank transfer of funds. The transfer may be made for a first installment amount, as specified in the installment terms for the created transfer. In an exemplary embodiment, the issuing institution 106 may transfer the first installment amount from the first transaction account to the installment number identified by the CPN platform 112. In such an embodiment, the issuing institution 106 may not possess the account number for the second transaction account, thus providing increased account security. In such embodiments, the receiving institution 108 may be provided with the installment number and the second transaction account associated therewith (e.g., by the CPN platform 112 or installment platform 110 as part of the creation of the installment), or the installment number may be remapped to the account number associated with the second transaction account during the fund transfer. For instance, the fund transfer may be processed using the installment platform 110 or other authorized system that may be configured to remap the CPN into the account number for the second transaction account before the data is provided to the receiving institution 108.

The use of the installment number may be useful for ensuring that payments made to the receiving institution 108 from the issuing institution 106 are attributed to the correct installment. For instance, the user 104 may be a participant in a plurality of different installments using the first transaction account, while the second transaction account may be the beneficiary of several installments that may include other users. In such cases, the installment platform 110 may identify a number of transfers being made from the issuing institution 106 to the receiving institution 108, which may not identify any transaction account directly, or may be performed in a batch process where a single payment is made to the receiving institution 108 by the issuing institution 106 for a settlement amount, without source account information being identified. In such cases, the use of installment numbers, which are unique to each installment, may ensure that installment payments are tracked successfully.

For instance, in an example, three different users 104 may create installments for payment from three separate accounts issued by the issuing institution 106 to a single account issued by the receiving institution 108, where each installment payment is to be $50. In such an example, the settlement process between the issuing institution 106 and receiving institution 108 may include a payment of $100 that, traditionally, would specify the single transaction account as the account to receive payment. In such traditional inter-bank transactions, the installment platform 110 would be unable to identify the two transaction accounts from which the payments were made, and which transaction account did not make the payment. In the system 100, the installment numbers may be used such that the installment platform 110 can easily identify which installment each payment corresponds to, while still enabling the receiving institution 108 to credit the second transaction account properly.

The methods and systems discussed herein thus enable installments to be created for inter- and intra-bank transfers in real-time. The computing device 102 may be utilized by the user 104 to facilitate the creation of an installment for an inter-bank or intra-bank transfer in real-time, enabling the user 104 to select and accept installment terms and receive an installment number to be used in the installment payments that can be used to successfully attribute all installment payments made by the user 104 without requiring modification to existing transfer and settlement processes by issuing institutions. As a result, installments may be quickly, and successfully implemented for inter-bank transactions, which cannot be performed using traditional financial systems.

### Computing Device

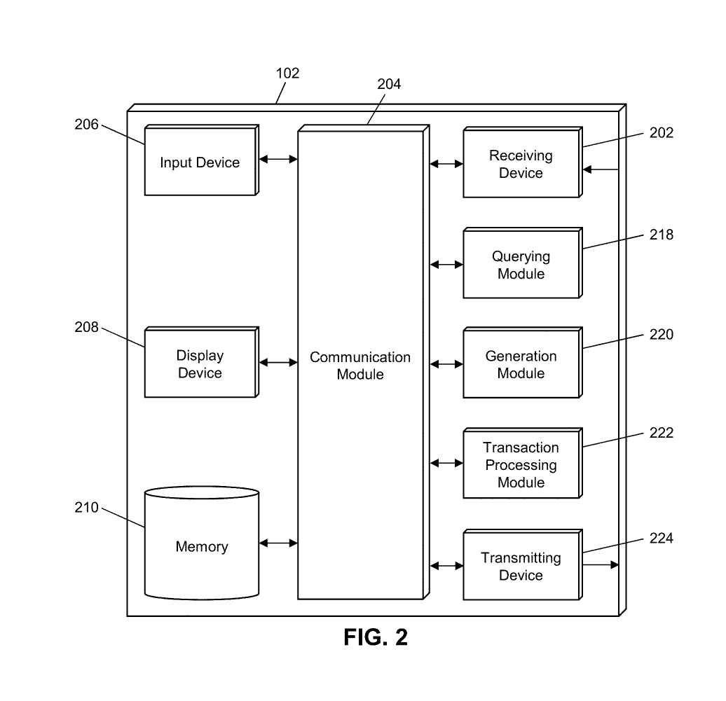

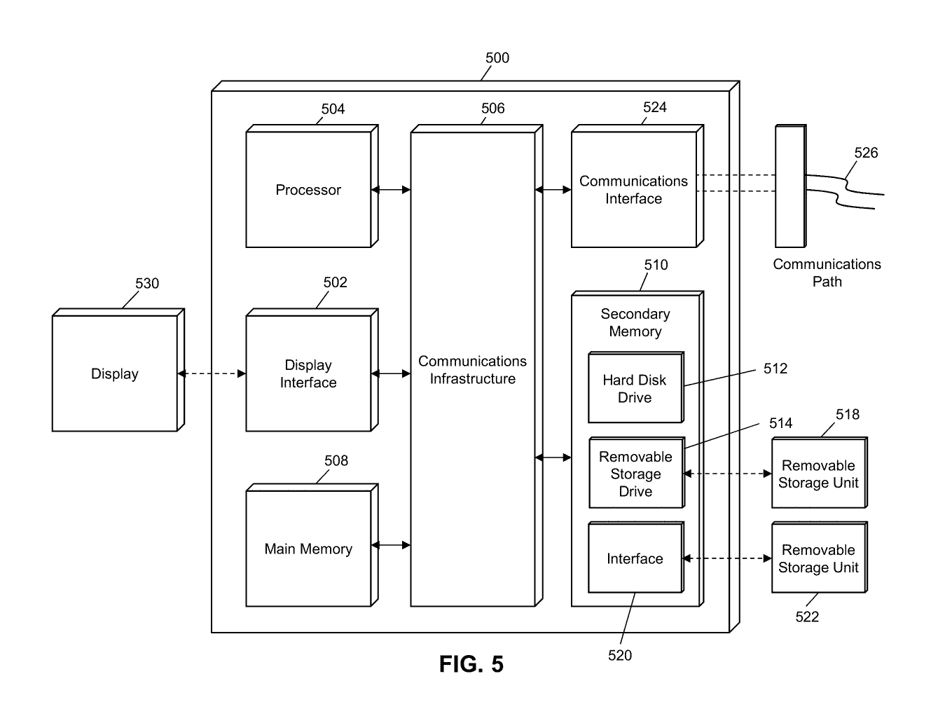

FIG. 2 illustrates an embodiment of a computing device 102 in the system 100. It will be apparent to persons having skill in the relevant art that the embodiment of the computing device 102 illustrated in FIG. 2 is provided as illustration only and may not be exhaustive to all possible configurations of the computing device 102 suitable for performing the functions as discussed herein. For example, the computer system 500 illustrated in FIG. 5 and discussed in more detail below may be a suitable configuration of the computing device 102.

The computing device 102 may include a receiving device 202. The receiving device 202 may be configured to receive data over one or more networks via one or more network protocols. In some instances, the receiving device 202 may be configured to receive data from issuing institutions 106, receiving institutions 108, installment platforms 110, CPN platforms 112, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by issuing institutions 106 that are superimposed or otherwise encoded with account credentials associated with a first transaction account. The receiving device 202 may also be configured to receive data signals electronically transmitted by receiving institutions 108, which may be superimposed or otherwise encoded with an account number or other identification data associated with a second transaction account. The receiving device 202 may be further configured to receive data signals electronically transmitted by the installment platform 110, which may be superimposed or otherwise encoded with installment terms, eligibility decisions, installment numbers, notifications of payment, or other data as indicated herein. In some embodiments, the receiving device 202 may be configured to receive data signals electronically transmitted by CPN platforms 112, such as may be superimposed or otherwise encoded with an installment number, which may also be accompanied by a reference number or other value identifying an installment to which the installment number is associated.

The computing device 102 may also include a communication module 204. The communication module 204 may be configured to transmit data between modules, engines, databases, memories, and other components of the computing device 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the computing device 102 and external components of the computing device 102, such as externally connected databases, display devices, input devices, etc. The computing device 102 may also include a processing device. The processing device may be configured to perform the functions of the computing device 102 discussed herein as will be apparent to persons having skill in the relevant art. In some embodiments, the processing device may include and/or be comprised of a plurality of engines and/or modules specially configured to perform one or more functions of the processing device, such as a querying module 218, generation module 220, transaction processing module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

The computing device 102 may also include or be otherwise interfaced with one or more input devices 206. The input devices 206 may be internal to the computing device 102 or external to the computing device 102 and connected thereto via one or more connections (e.g., wired or wireless) for the transmission of data to and/or from. The input devices 206 may be configured to receive input from a user of the computing device 102, such as the user 104, which may be provided to another module or engine of the computing device 102 (e.g., via the communication module 204) for processing accordingly. Input devices 206 may include any type of input device suitable for receiving input for the performing of the functions discussed herein, such as a keyboard, mouse, click wheel, scroll wheel, microphone, touch screen, track pad, camera, optical imager, etc. The input device 206 may be configured to, for example, receive an account number associated with the second transaction account and a full payment amount as input by the user 104, and receive an indication of acceptance or selection of installment terms by the user 104.

The computing device 102 may also include or be otherwise interfaced with a display device 208. The display device 208 may be internal to the computing device 102 or external to the computing device 102 and connected thereto via one or more connections (e.g., wired or wireless) for the transmission of data to and/or from. The display device 208 may be configured to display data to a user of the computing device 102, such as the user 104. The display device 208 may be any type of display suitable for displaying data as part of the functions discussed herein, such as a liquid crystal display, light emitting diode display, thin film transistor display, capacitive touch display, cathode ray tube display, light projection display, etc. In some instances, the computing device 102 may include multiple display devices 208. The display device 208 may be configured to, for example, display installment terms to the user 104 as received from the installment platform 110 for selection or acceptance by the user 104, and for display of an installment number and other data notifying the user 104 of the creation of an installment.

The computing device 102 may also include a memory 210. The memory 210 may be configured to store data for use by the computing device 102 in performing the functions discussed herein, such as public and private keys, symmetric keys, etc. The memory 210 may be configured to store data using suitable data formatting methods and schema and may be any suitable type of memory, such as read-only memory, random access memory, etc. The memory 210 may include, for example, encryption keys and algorithms, communication protocols and standards, data formatting standards and protocols, program code for modules and application programs of the processing device, and other data that may be suitable for use by the computing device 102 in the performance of the functions disclosed herein as will be apparent to persons having skill in the relevant art. In some embodiments, the memory 210 may be comprised of or may otherwise include a relational database that utilizes structured query language for the storage, identification, modifying, updating, accessing, etc. of structured data sets stored therein.

The memory 210 may be configured to store, for example, account credentials associated with the first transaction account. The memory 210 may also be configured to store data and preferences of the user 104, such as preferred installment terms, criteria set by the user 104 for the automatic acceptance of an installment, previously received installment numbers and corresponding installment identification data, etc. The memory 210 may also include program code for an application program for execution by a processor of the computing device 102 for providing an interface to the user 104 for performing the functions discussed herein. In some embodiments, the application program may be associated with the issuing institution 106, or may be associated with the installment platform 110. In some cases, a separate application program may be used for communication with the CPN platform 112.

The computing device 102 may include a querying module 218. The querying module 218 may be configured to execute queries on databases to identify information. The querying module 218 may receive one or more data values or query strings, and may execute a query string based thereon on an indicated database, such as the memory 210, to identify information stored therein. The querying module 218 may then output the identified information to an appropriate engine or module of the computing device 102 as necessary. The querying module 218 may, for example, execute a query on the memory 210 to identify account credentials stored therein for inclusion in an eligibility request for submission to the installment platform 110 for the creation of a new installment.

The computing device 102 may also include a generation module 220. The generation module 220 may be configured to generate data for use by the computing device 102 in performing the functions discussed herein. The generation module 220 may receive instructions as input, may generate data as instructed, and may output the generated data to another module or engine of the computing device 102. For example, the generation module 220 may be configured to generate an eligibility request that includes account credentials associated with the first transaction account, the account number associated with the second transaction account, and the full payment amount to be made via the installment. In some cases, the data to be used by the generation module 220 may be included in the input. In other cases, the generation module 220 may be configured to identify such data (e.g., such as by instructing the querying module 218 to execute queries on the memory 210).

The computing device 102 may also include a transaction processing module 222. The transaction processing module 222 may be configured to perform functions associated with the processing of payment transactions, including installment payments, that will be apparent to persons having skill in the relevant art. For example, the payment processing mechanism of U.S. Pat. No. 9,785,933 (System and Method for Installment Load Transactions), which issued on Oct. 1, 2017, or U.S. Published Patent Application No. 2016-0321634, which published Nov. 3, 2016 (Method and System for POS Enabled Installments with Eligibility Check Requirements), both of which are herein incorporated by reference, could be adapted for use in this system. For instance, the transaction processing module 222 may be configured to submit data, such as an installment number and installment amount to the issuing institution 106 for initiation of a transfer from the first transaction account to the installment number for the installment amount, maintain account credentials, operate an electronic wallet, etc.

The computing device 102 may also include a transmitting device 224. The transmitting device 224 may be configured to transmit data over one or more networks via one or more network protocols. In some instances, the transmitting device 224 may be configured to transmit data to issuing institutions 106, receiving institutions 108, installment platforms 110, CPN platforms 112, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to issuing institutions 106 that are superimposed or otherwise encoded with requests for account credentials or requests for inter-bank transfers, which may include an installment number and installment amount as received by the computing device 102 using the methods discussed herein. In some embodiments, the transmitting device 224 may be configured to transmit data signals to receiving institutions 108, which may be superimposed or otherwise encoded with a request for an account number, and may include information identifying the transaction account for which an account number is requested. The transmitting device 224 may also be configured to electronically transmit data signals to installment platforms 110, which may be superimposed or otherwise encoded with eligibility requests, acceptances of installment terms, selections of installment terms, desired installment terms, identified installment numbers, etc. In some embodiments, the transmitting device 224 may be further configured to electronically transmit data signals to CPN platforms 112, which may be superimposed or otherwise encoded with a request for a CPN, which may include the account number associated with the second transaction account or other identifying data, and/or may include a reference number associated with an installment being created.

### Process for Creation of a Real-Time Installment for an Inter-Bank Transaction

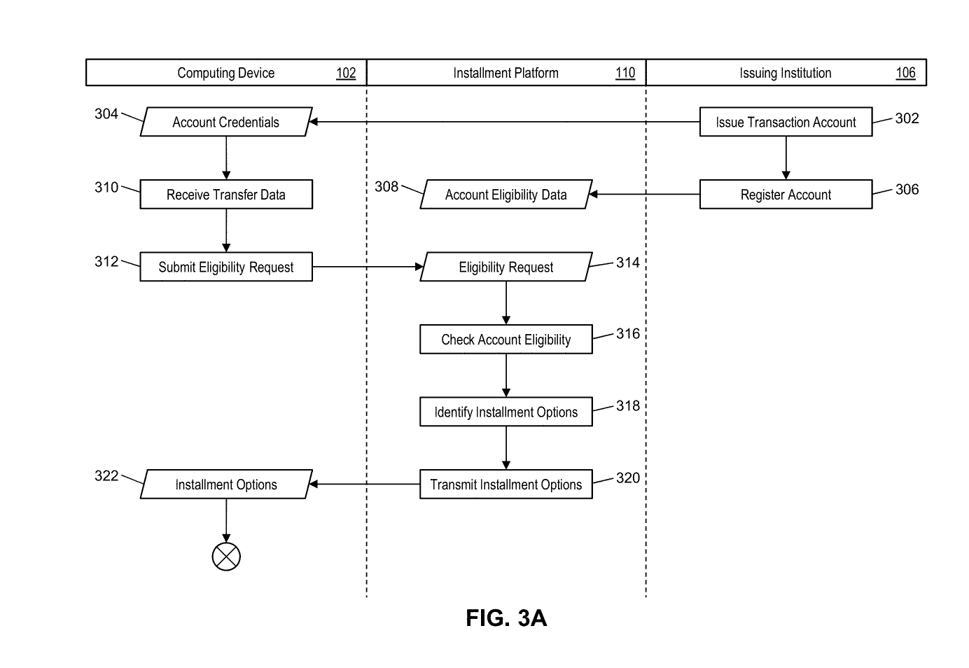

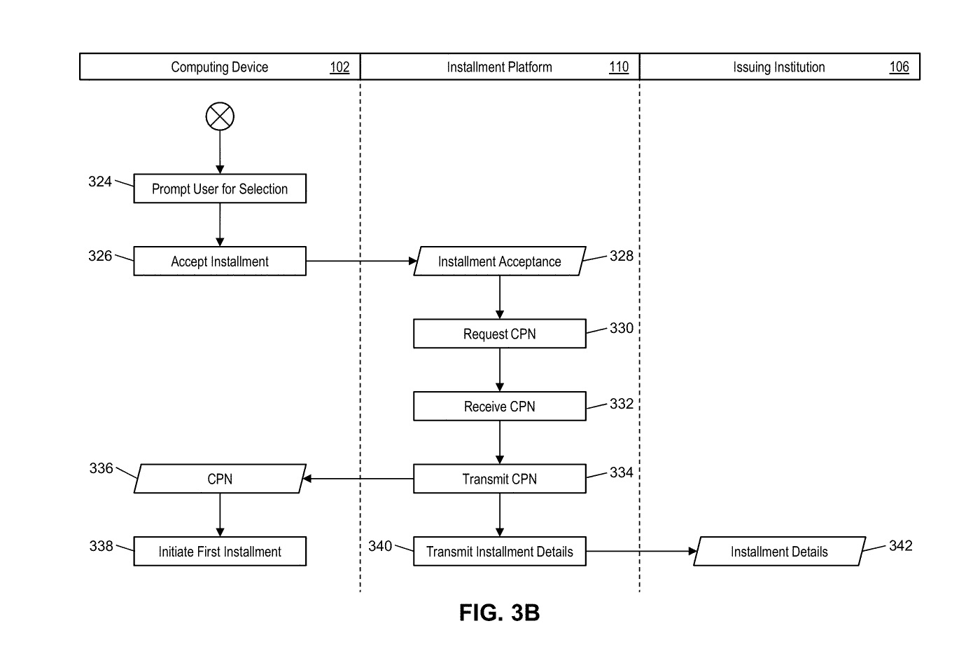

FIGS. 3A and 3B illustrate an example process executed in the system 100 of FIG. 1 for the creation of an installment in real-time to facilitate an inter-bank transaction between the issuing institution 106 and the receiving institution 108 as requested by the user 104 using the computing device 102.

In step 302, the issuing institution 106 may issue a first transaction account to the user 104 that is eligible for use in inter-bank transactions and eligible for installments, which may include the provisioning of account credentials associated with the transaction account to the computing device 102. In step 304, the receiving device 202 of the computing device 102 may receive the account credentials which may be stored in the memory 210 thereof via the execution of a query on the memory 210 by the querying module 218 of the computing device 102.

In step 306, the issuing institution 106 may register the first transaction account with the installment platform 110 as being eligible for use in installments for inter-bank transactions. In step 308, the installment platform 110 may receive the account eligibility data. The account eligibility data may include at least an account number or other identifying data associated with the first transaction account and may, in some cases, also include parameters regarding acceptable installment terms for installments involving the first transaction account.

In step 310, the computing device 102 may receive data regarding an inter-bank transfer. The data may include at least an account number associated with a second transaction account to which an amount is to be transferred, and the total payment amount to be made via the transfer. In some cases, all of the data may be input by the user 104 via an input device 206 of the computing device 102. In other cases, data may be received by the receiving device 202 of the computing device 102, such as from the receiving institution 108. In some instances, the transfer data may be received from multiple sources (e.g., the account number from the receiving institution 108 via the receiving device 202 and the payment amount via the input device 206). In step 312, the transmitting device 224 of the computing device 102 may electronically transmit an eligibility request to the installment platform 110 using a suitable communication method. In step 314, the installment platform 110 may receive the eligibility request. The eligibility request may include at least the account number associated with the second transaction account, full payment amount, and the account credentials associated with the first transaction account.

In step 316, the installment platform 110 may check the eligibility of the first transaction account as submitted in the eligibility request. The check may be to ensure that the first transaction account was previously registered, as occurred in steps 306 and 308, discussed above. If the account is eligible for payment of the inter-bank transfer via installments, then, in step 318, the installment platform 110 may identify proposed installment options for the installment. In cases where the issuing institution 106 provides parameters as part of the registration of the first transaction account, such parameters may be used by the installment platform 110 in identifying the proposed installment options. In instances where the user 104 may specify desired installment options in the eligibility request, the desired installment options may be followed or otherwise used by the installment platform 110. In some cases, the installment platform 110 may identify multiple sets of installment options for selection by the user 104.

In step 320, the installment platform 110 may transmit the identified installment options to the computing device 102 using a suitable communication method and network. In step 322, the receiving device 202 of the computing device 102 may receive the installment options. In step 324, the display device 208 of the computing device 102 may display the installment options to the user 104 and may prompt the user 104 to select one of the sets of installment options or otherwise indicate acceptance of a presented set of installment options. In step 326, the input device 206 of the computing device 102 may receive input of the user's selection/acceptance of a set of installment options and the transmitting device 224 of the computing device 102 may electronically transmit the indication of acceptance of a specific set of installment options to the installment platform 110.

In step 328, the installment platform 110 may receive the indication of acceptance of a set of installment options. In step 330, the installment platform 110 may submit a request for a CPN to the CPN platform 112. In some cases, the request may include the account number associated with the second transaction account. In other cases, the request may include alternative data that otherwise identifies the second transaction account. In some instances, the request may also include a reference number associated with the installment. In step 332, the installment platform 110 may receive a CPN from the CPN platform 112 that is associated with the second transaction account and unique to the installment. In some instances, the CPN may be accompanied by the reference number.

In step 334, the installment platform 110 may electronically transmit the CPN to the computing device 102. In step 336, the receiving device 202 of the computing device 102 may receive the CPN. The user 104 may then proceed to, in step 338, initiate the first installment payment for the installment for transfer of a first installment amount (e.g., as defined in the accepted set of installment options) from the first transaction account to the CPN. In some instances, step 338 may be conducted by the issuing institution 106. In step 340, the installment platform 110 may provide details regarding the installment to the issuing institution 106. In step 342, the issuing institution 106 may receive the details. The details may include at least the accepted installment options, information identifying the first transaction account, and the CPN. In some embodiments, the issuing institution 106 may initiate the first installment payment to the CPN from the first transaction account. In other embodiments, the issuing institution 106 may transfer the full payment amount to the receiving institution 108 via the CPN and may deduct the installment amount from the first transaction account at the specified intervals as indicated in the installment options.

### Exemplary Method for Creating an Installment for an Inter-Bank Transaction

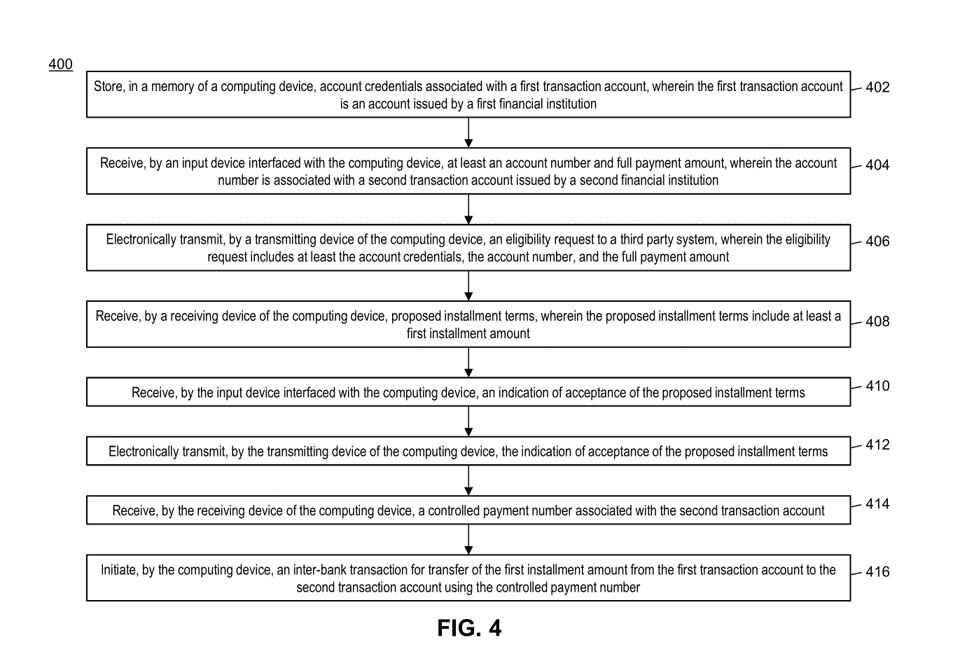

FIG. 4 illustrates a method 400 for the creation of an installment for an inter-bank transaction via the use of a controlled payment number and a third party installment platform.

In step 402, account credentials associated with a first transaction account may be stored in a memory (e.g., the memory 210) of a computing device (e.g., the computing device 102), wherein the first transaction account is an account issued by a first financial institution (e.g., the issuing institution 106). In step 404, at least an account number and full payment amount may be received by an input device (e.g., an input device 206) interfaced with the computing device, wherein the account number is associated with a second transaction account issued by a second financial institution (e.g., the receiving institution 108).

In step 406, an eligibility request may be electronically transmitted by a transmitting device (e.g., the transmitting device 224) of the computing device to a third party system (e.g., the installment platform 110), wherein the eligibility request includes at least the account credentials, the account number, and the full payment amount. In step 408, proposed installment terms may be received by a receiving device (e.g., the receiving device 202) of the computing device, wherein the proposed installment terms include at least a first installment amount. In step 410, an indication of acceptance of the proposed installment terms may be received by the input device interfaced with the computing device.

In step 412, the indication of acceptance of the proposed installment terms may be electronically transmitted by the transmitting device of the computing device. In step 414, a controlled payment number associated with the second transaction account may be received by the receiving device of the computing device. In step 416, an inter-bank transaction may be initiated by the computing device for transfer of the first installment amount form the first transaction account to the second transaction account using the controlled payment number.

In one embodiment, the proposed installment terms may be received from an external computing system different from the third party system. In a further embodiment, the external computing system may be operated by the first financial institution. In another further embodiment, the controlled payment number may be received from the third party system. In yet another further embodiment, the controlled payment number may be received from an additional computing system (e.g., the CPN platform 112) different from the external computing system and the third party system.

In some embodiments, the proposed installment terms may be received from the third party system. In one embodiment, the proposed installment terms may include a plurality of numbers of payments and, for each number of payments, an associated installment amount, where the first installment amount is one of the associated installment amounts, and the indication of acceptance of the proposed installment terms includes a selected number of payments of the plurality where the associated installment amount is the first installment amount. In some embodiments, initiating the inter-bank transaction may include electronically transmitting, by the transmitting device of the computing device, at least the controlled payment number and first installment amount to the first issuing institution. In one embodiment, the third party system may be configured to electronically transmit at least the account credentials, proposed installment terms, and controlled payment number to the first issuing institution.

### Computer System Architecture

FIG. 5 illustrates a computer system 500 in which embodiments of the present disclosure, or portions thereof, may be implemented as computer-readable code. For example, the computing device 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B, and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3A, 3B, and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for creating an installment for an inter-bank transaction. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for creating an installment for an inter-bank transaction, comprising:
storing, in a memory of a computing device, account credentials associated with a first transaction account, wherein the first transaction account is an account issued by a first financial institution;
receiving, by an input device interfaced with the computing device, at least an account number and full payment amount, wherein the account number is associated with a second transaction account issued by a second financial institution;
electronically transmitting, by a transmitting device of the computing device, an eligibility request to a third party system, wherein the eligibility request includes at least the account credentials, the account number, and the full payment amount;
receiving, by a receiving device of the computing device, proposed installment terms, wherein the proposed installment terms include at least a first installment amount;
receiving, by the input device interfaced with the computing device, an indication of acceptance of the proposed installment terms;
electronically transmitting, by the transmitting device of the computing device, the indication of acceptance of the proposed installment terms;
receiving, by the receiving device of the computing device, a controlled payment number associated with the second transaction account; and
initiating, by the computing device, an inter-bank transaction for transfer of the first installment amount from the first transaction account to the second transaction account using the controlled payment number.

2. The method of claim 1, wherein the proposed installment terms are received from an external computing system different from the third party system.

3. The method of claim 2, wherein the external computing system is operated by the first financial institution.

4. The method of claim 2, wherein the controlled payment number is received from the third party system.

5. The method of claim 2, wherein the controlled payment number is received from an additional computing system different from the external computing system and the third party system.

6. The method of claim 1, wherein the proposed installment terms are received from the third party system.

7. The method of claim 1, wherein the proposed installment terms further include at least one of: number of payments, installment period, interest rate, and fees.

8. The method of claim 1, wherein
the proposed installment terms includes a plurality of numbers of payments and, for each number of payments, an associated installment amount, where the first installment amount is one of the associated installment amounts,
the indication of acceptance of the proposed installment terms includes a selected number of payments of the plurality where the associated installment amount is the first installment amount.

9. The method of claim 1, wherein initiating the inter-bank transaction includes electronically transmitting, by the transmitting device of the computing device, at least the controlled payment number and first installment amount to the first issuing institution.

10. The method of claim 1, wherein the third party system is configured to electronically transmit at least the account credentials, proposed installment terms, and controlled payment number to the first issuing institution.

11. A system for creating an installment for an inter-bank transaction, comprising:
a memory of a computing device configured to store account credentials associated with a first transaction account, wherein the first transaction account is an account issued by a first financial institution;
an input device interfaced with the computing device configured to receive at least an account number and full payment amount, wherein the account number is associated with a second transaction account issued by a second financial institution;
a transmitting device of the computing device configured to electronically transmit an eligibility request to a third party system, wherein the eligibility request includes at least the account credentials, the account number, and the full payment amount; and
a receiving device of the computing device configured to receive proposed installment terms, wherein the proposed installment terms include at least a first installment amount, wherein
the input device interfaced with the computing device is further configured to receive an indication of acceptance of the proposed installment terms,
the transmitting device of the computing device is further configured to electronically transmit the indication of acceptance of the proposed installment terms,
the receiving device of the computing device is further configured to receive a controlled payment number associated with the second transaction account, and
the computing device is configured to initiate an inter-bank transaction for transfer of the first installment amount from the first transaction account to the second transaction account using the controlled payment number.

12. The system of claim 11, wherein the proposed installment terms are received from an external computing system different from the third party system.

13. The system of claim 12, wherein the external computing system is operated by the first financial institution.

14. The system of claim 12, wherein the controlled payment number is received from the third party system.

15. The system of claim 12, wherein the controlled payment number is received from an additional computing system different from the external computing system and the third party system.

16. The method of claim 11, wherein the proposed installment terms are received from the third party system.

17. The method of claim 11, wherein the proposed installment terms further include at least one of: number of payments, installment period, interest rate, and fees.

18. The method of claim 11, wherein
the proposed installment terms includes a plurality of numbers of payments and, for each number of payments, an associated installment amount, where the first installment amount is one of the associated installment amounts,
the indication of acceptance of the proposed installment terms includes a selected number of payments of the plurality where the associated installment amount is the first installment amount.

19. The method of claim 11, wherein initiating the inter-bank transaction includes electronically transmitting, by the transmitting device of the computing device, at least the controlled payment number and first installment amount to the first issuing institution.

20. The method of claim 11, wherein the third party system is configured to electronically transmit at least the account credentials, proposed installment terms, and controlled payment number to the first issuing institution.
